(19) United States
(12) Patent Application Publication
(10) Pub. No.: US 2025/0248435 A1
(43) Pub. Date: Aug. 7, 2025

(54) NOZZLE FOR A FOOD PRINTER

(71) Applicant: Logistics and Supply Chain MultiTech R&D Centre Limited, Pok Fu Lam (HK)

(72) Inventor: King Sau WONG, Pok Fu Lam (HK)

(21) Appl. No.: 18/435,059

(22) Filed: Feb. 7, 2024

(51) Int. Cl. A23P 20/25; B05C 5/02

(52) U.S. Cl. CPC A23P 20/25; B05C 5/0229; A23P 2020/253

(57) ABSTRACT

A nozzle for a food printer including a nozzle head in fluid communication with an edible ink source and arranged to discharge one or more edible inks, wherein the nozzle head includes a plurality of nozzle blade components being movable relative to each other and an opening formed by the plurality of nozzle blade components through which the edible ink is discharged; and a nozzle adjusting mechanism configured to adjust the relative position of the nozzle blade components whereby the dimension of the opening of the nozzle head is adjustable to discharge edible ink with different dimensions so as to print a food material.

### TECHNICAL FIELD

The invention relates to a nozzle for a printer, although not exclusively, to a nozzle for a food printer.

### BACKGROUND

3D printing or additive manufacturing (AM) refers to the construction of a three-dimensional object from a 3D model. 3D printing has already touched many industries and can be widely adopted in many areas such as rapid prototype for proof of concept, customized machine parts, accessories etc.

To prepare the ground work for 3D printing, it is necessary to build a programmed shape and create a 3D printable model with a computer-aided design (CAD) or through a 3D scanner. The usual material for 3D printing would be plastics and metals. During a 3D printing, the 3D printer deposits the printing material through a nozzle onto a surface to build up the preprogrammed shape layer by layer.

However, the adoption of 3D printing in food industry is more challenging. Unlikely printing with the convention inks, the food ink used in 3D food printer requires very precise control of the material properties. Because of the varied material properties of the food ink, print head nozzles with different nozzle size are required to accommodate different food inks. If a preprogrammed food material involves a large variety of food ingredients, it would require frequent switching between different print head nozzles which is very time consuming and labor intensive. Moreover, the nozzle during the interim of the printing task can be very hot and the operator has to handle it carefully to avoid burns.

### SUMMARY OF THE INVENTION

In accordance with a first aspect of the present invention, there is provided a nozzle for a food printer, comprising:
a nozzle head in fluid communication with an edible ink source and arranged to discharge one or more edible inks, wherein the nozzle head comprises a plurality of nozzle blade components being movable relative to each other and an opening formed by the plurality of nozzle blade components through which the edible ink is discharged; and
a nozzle adjusting mechanism configured to adjust the relative position of the nozzle blade components whereby the dimension of the opening of the nozzle head is adjustable to discharge edible ink with different dimensions so as to print a food material.

In accordance with the first aspect, the nozzle adjusting mechanism further includes a movable mount plate arranged to actuate the relative movement of the nozzle blade components.

In accordance with the first aspect, the nozzle adjusting mechanism further includes a stationary mount plate arranged to guide the relative movement of the nozzle blade components.

In accordance with the first aspect, the nozzle adjusting mechanism further includes a first pin and slot arrangement for transmitting the motion from the movable mount plate to the nozzle blade components.

In accordance with the first aspect, the nozzle adjusting mechanism further includes a second pin and slot arrangement for guiding the movement of the nozzle blade component relative to the stationary mount plate.

In accordance with the first aspect, the nozzle blade components each includes an outer portion together forming the nozzle head and an inner portion interacting with the movable mount plate and the stationary mount plate respectively so as to adjust the position of the outer portion and the dimension of the opening.

In accordance with the first aspect, the outer portion of the nozzle blade component is exposed from the movable mount plate and the inner portion of the nozzle blade component is sandwiched between the movable mount plate and the stationary mount plate.

In accordance with the first aspect, the movable mount plate is a circulate guide mount rotatable about a rotating axis and includes an opening through which the outer portion is exposed.

In accordance with the first aspect, the stationary mount plate is a circulate guide mount being stationary relative to the movable mount plate.

In accordance with the first aspect, each of the inner portion of the nozzle blade component includes a first pin extending vertically from a plane of the nozzle blade component and the movable mount plate further includes a first plurality of slots each receiving a respective first pin of the nozzle blade component whereby the movement of each nozzle blade component is driven by the interaction between the first pins and the slots.

In accordance with the first aspect, each of the inner portion of the nozzle blade component includes a second pin extending vertically from a plane of the nozzle blade component and the stationary mount plate further includes a second plurality of slots each arranged to mate with a respective second pin of the nozzle blade component so as to facilitate the movement of each nozzle blade component driven by the movable mount plate.

In accordance with the first aspect, the longitudinal length of the first slot forms an acute angle with a center line of the movable mount plate.

In accordance with the first aspect, the movable mount plate further includes a trigger handle protruding from the movable mount plate and the nozzle adjusting mechanism further includes a push arm driven by an actuator whereby the position of the movable mount plate is manipulated by the actuator through the mechanical transmission from the push arm to the trigger handle.

In accordance with the first aspect, the push arm is pivotable about a pivoting axis whereby the pivotal movement of the push arm is arranged to push the trigger handle so as to adjust the dimension of the opening.

In accordance with the first aspect, the push arm includes two extending arms each operable to push the trigger handle from opposite directions respectively.

In accordance with the first aspect, the nozzle adjusting mechanism is actuated by a servo actuator.

In accordance with the first aspect, further comprising a housing arranged to contain the nozzle adjusting mechanism.

In accordance with the first aspect, the housing further includes a slot through which the trigger handle is exposed from the housing so as to be accessible by the push arm and the two ends of the slot being a stopper whereby the degree of the movement of the trigger handle is limited.

In accordance with the first aspect, at least one of the nozzle blade components is symmetrical.

In accordance with the first aspect, at least two of the nozzle blade components are identical.

### BRIEF DESCRIPTION OF THE DRAWINGS

Embodiments of the present invention will now be described, by way of example, with reference to the accompanying drawings in which:

FIG. 1 is a top perspective view showing the partial view of a 3D food printer incorporating a nozzle in accordance with an embodiment of the present invention;

FIG. 2 is a telescopic view showing the 3D food printer and the nozzle head of FIG. 1 in further details;

FIG. 3 is a partial view showing the nozzle adjusting mechanism of the nozzle head of FIG. 2;

FIG. 4 is an explosive view showing the multiple components of the nozzle head of

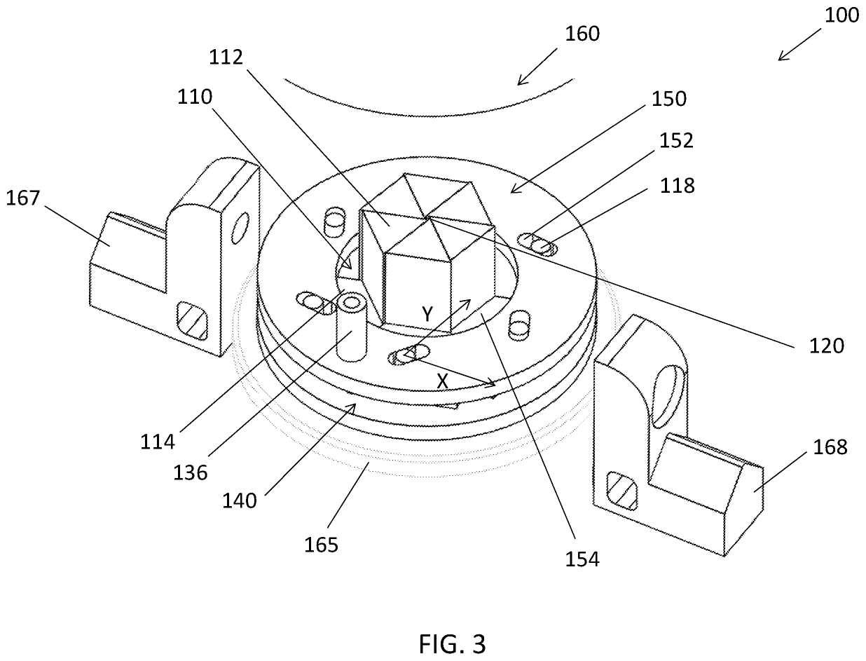

FIG. 2;

FIG. 5 is an isolated view showing the lower movable guide mount of the nozzle head of FIG. 2;

FIG. 6A is a schematic diagram showing the nozzle head in close condition; and

FIG. 6B is a schematic diagram showing the nozzle head in open condition.

### DETAILED DESCRIPTION OF THE PREFERRED EMBODIMENTS

Without wishing to be bound by theory, the inventors have discovered that the print head nozzle size should be different for printing different kinds of food material in a general food printing process. To coop with the more complicated 3D printing tasks, the operator has to manually switch the print head nozzle of the traditional food printer with different nozzle size frequently. However, the nozzle cannot be changed during the printing process unless the printing operation of the 3D printer is interrupted and the heated nozzle head has been cooled down.

The present invention relates to a novel nozzle in which the nozzle size can be changed during the printing process. By incorporating a nozzle adjusting mechanism onto the nozzle tip, the nozzle size can be adjusted based on the required parameter and the same nozzle attachment may be used for printing different kinds of food material throughout the same printing task without tedious steps of detaching and reattaching the nozzle onto the 3D printer.

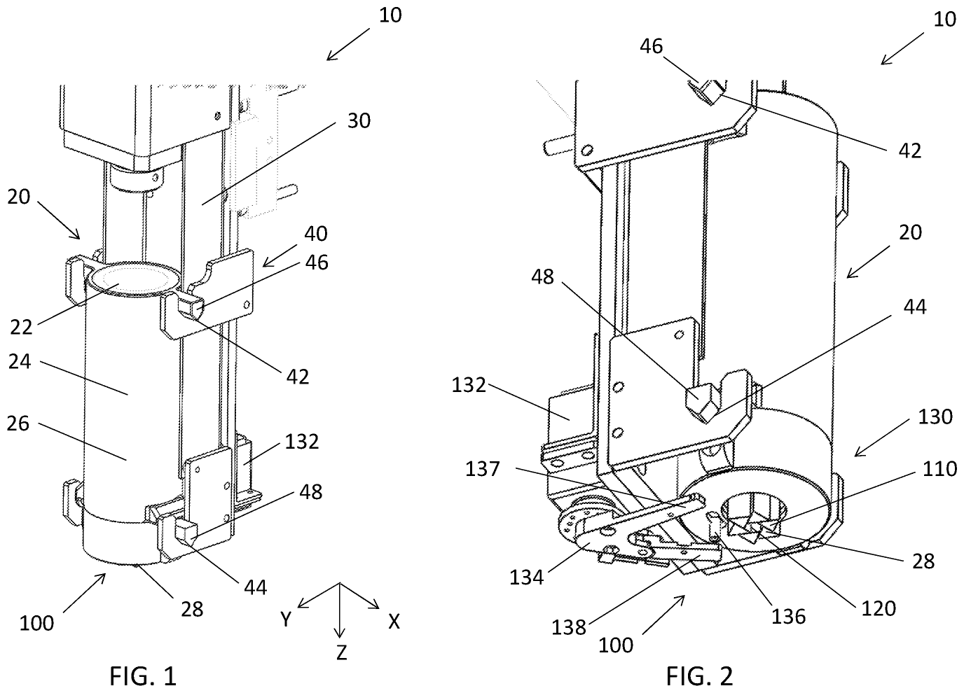

With reference to FIG. 1, there is shown an embodiment of a nozzle for a food printer 10, comprising: a nozzle head 100 in fluid communication with an edible ink source and arranged to discharge one or more edible inks, wherein the nozzle head 100 comprises a plurality of nozzle blade components 110 being movable relative to each other and an opening 120 formed by the plurality of nozzle blade components 110 through which the edible ink is discharged; and a nozzle adjusting mechanism 130 configured to adjust the relative position of the nozzle blade components 110 whereby the dimension of the opening 120 of the nozzle head 100 is adjustable to discharge edible ink with different dimensions so as to print a food material.

For the purposes of this document, the term “ink” includes any forms of printing materials, such as, but not limited to filaments. The term “edible ink” or “food ink” includes any type of edible substances, such as, but not limited to, ingredients in liquid or semi-solid form such as puree, paste, and dough e.g., chocolate, meat pastes, vegetable purees, cookie dough, liquid, juice, butter, sauces, jelly or nutrients such as carbohydrates, proteins, fats, vitamins and minerals. The term “food materials” includes any type of edible materials such as, but not limited to, raw materials such as meat, plants, or processed food materials such as plant-based meat or treated food such as 3D printed food meals, beverages or desserts. The use of the term “edible ink”, “food ink” and “food material” in the description hereinafter is not intended to limit the invention to the printing of food products, but rather is intended to be non-limiting. For instance, the “food material” prepared by the “edible ink” or “food ink” may also include an item which is partially formed by edible ink or food ink and also other inks of food grade materials that would come into direct contact with the food for human consumption.

As shown in FIG. 1 there is a shown a schematic diagram of a food printer 10. The food printer 10 may comprise a main control unit (not shown), one or more edible or food ink sources (not shown), a heating module (not shown) for heating up the edible or food ink e.g., so as to melt the edible or food ink into liquid state, a syringe-type extrusion mechanism 20 which includes a motor 22, a syringe 24, a plunger 26 for driving edible or food ink from one of the edible or food ink sources and extruding the specific edible or food ink via an extrusion nozzle tip 28 onto a printing plate or a building platform to build a food object. These components can be held on a movable station 30 which is movable along the x and y Cartesian direction for depositing the food ink in the designated coordinates. In one example embodiment, the movable station 30 may include a movement mechanism for providing the required XY lateral movement. For instance, the extrusion mechanism 20 may be slidably mounted onto a pair of guide rails and driven by two individual axis motors. The main control unit may execute one or more instructions and move the extrusion nozzle tip 28 to a particular position coordinate. Optionally, there may also be provided a third axis motor for controlling the vertical movement of the extrusion mechanism 20 in the z-axis.

For the ease of maintenance or replacement, the syringe-type extrusion mechanism can be held on the movable station 30 through an engaging mechanism 40. For instance, the mounting frame of the movable station 30 may include a pair of slots 42, 44 and the extrusion mechanism 20 may include a pair of upper hooks 46 and lower hooks 48 for hanging from the slots 42, 44 provided on the mounting frame of the movable station 30. At the lower end of the food printer 10, there is provide a novel nozzle head 100 which is at least partially embedded as part of the syringe-type extrusion mechanism 20. While the example embodiment describes a syringe-type extrusion, the novel nozzle head 100 may also be embodied as other types of 3D food extrusion mechanisms such as screw-type extrusion or air pressure-driven extrusion.

With reference now to FIG. 2, there is a shown one example embodiment of the nozzle head 100 in further details. The nozzle head 100 includes a plurality of nozzle blade components 110 together forming the extrusion nozzle tip 28 with an opening 120 which is variable based on the relative positions of the nozzle blade components 110. The shape of the opening 120 depends on the contour of the nozzle blade components 110. For instance, the opening 120 can be circular or non-circular depending on the number of nozzle blade components 110 and the shape of the nozzle blade components 110.

In this illustrative example embodiment, there is provided six identical nozzle blade components 110 with symmetrical shape. When the nozzle blade components 110 are moved away from the center, a hexagonal opening 120 would present in the center of the extrusion nozzle tip 28. While the present embodiment suggests the use of six nozzle blade components 110, the nozzle head 100 may also be formed by at least two nozzle blade components 110 and more preferably the number of nozzle blade components 110 is a multiple of two. For instance, the nozzle head 100 may be formed by eight nozzle blade components 110 and an octagonal opening 120 would present in the center of the extrusion nozzle tip 28. The nozzle head 100 may be formed by ten nozzle blade components 110 and a decagonal opening 120 would present in the center of the extrusion nozzle tip 28. The nozzle head 100 may also be formed by twelve nozzle blade components 110 and a dodecagonal opening 120 would present in the center of the extrusion nozzle tip 28. The nozzle head 100 may also be formed by odd number of nozzle blade components 110 to give a nozzle opening 120 in pentagonal, heptagonal, nonagonal or hendecagonal etc. The higher the number of nozzle blade components 110, the more rounded the nozzle opening 120 would be. Alternatively, the nozzle head 100 may also be formed by non-identical and asymmetrical nozzle blade components 110.

There is also provided a nozzle adjusting mechanism 130 for controlling the opening and closing of the extrusion nozzle tip 28. Advantageously, the nozzle adjusting mechanism 130 may change the relative position of the nozzle blade components 110 progressively so that the nozzle adjusting mechanism 130 may provide a fine adjustment to the opening 120 of the extrusion nozzle tip 28.

In one example embodiment as shown in FIG. 2, the open and close of the nozzle adjusting mechanism 130 can be controlled by the command of the main control unit. The nozzle adjusting mechanism 130 may further include an external servo actuator 132 adjacent to the extrusion nozzle tip 28 to trigger the movement of the nozzle blade components 110. The servo actuator 132 may be a rotary servo actuator which includes an internal motor for providing rotational output in terms of torque and a gearbox for further amplifying the rotational torque transmitting to an output shaft. The rotary servo actuator 132 may create a circular motion of the output shaft in fixed degrees. A push arm 134 is connected to the output shaft and thus driven by the servo actuator 132 and moved in a reciprocating circular motion within fixed degrees. The output shaft of the servo actuator 132 and the push arm 134 are each rotatable about an axis parallel to the longitudinal length of the syringe-type extrusion mechanism 20. Optionally, there may also be provided an integrated position sensor such that the internal motor can accurately position the output shaft and thus push arm 134. There is also provided a trigger handle 136 proximate to the extrusion nozzle 28 which may be triggered by the push arm 134 to adjust the relative position of the nozzle blade components 110.

More particularly, the push arm 134 may be incorporated as a Y-shaped push arm which includes two limbs 137, 138 each having an inner face for abutting the trigger handle 136 from different directions so as to depress the trigger handle 136. For instance, the servo actuator 132 may turn the Y-shaped push arm 134 on the trigger handle 136. As the trigger handle 136 turns, the opening 120 of the nozzle head 100 will open or close dependent upon the position of the trigger handle 136. When the push arm 134 is rotated about the axis in an anticlockwise direction (viewing from the top of the food printer 10), the inner face of the limb 137 will depress the trigger handle 136 and trigger the increase in the dimension of the opening 120. On the other hand, when the push arm 134 is rotated about the axis in a clockwise direction (viewing from the top of the food printer 10), the inner face of the limb 138 will depress the trigger handle 136 and trigger the decrease in the dimension of the opening 120. Thus, the size of the nozzle opening 120 can be adjusted at a very fine level.

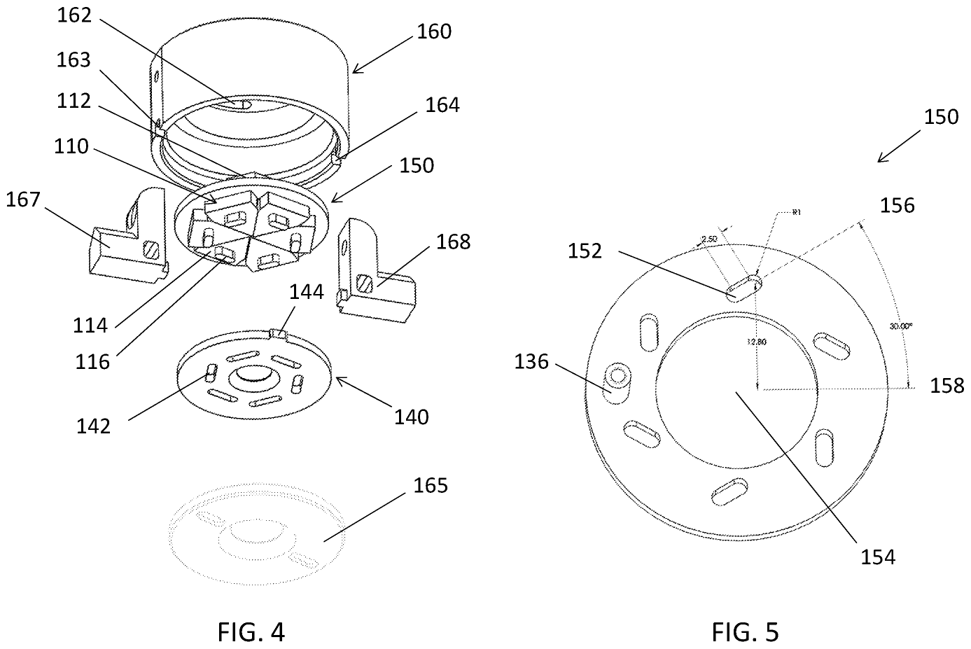

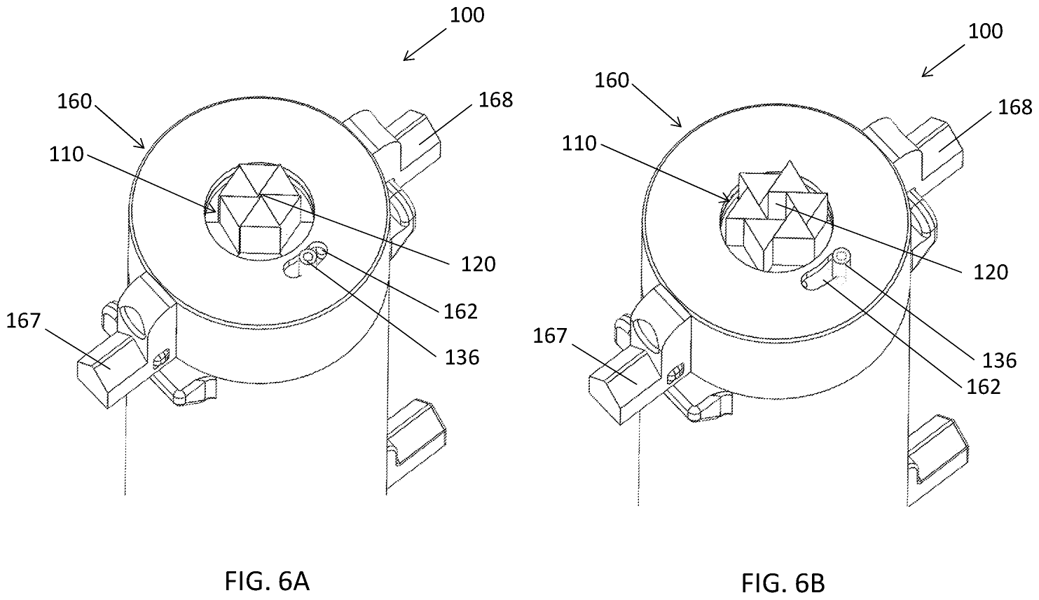

With reference to FIGS. 3 and 4, there is shown the nozzle adjusting mechanism 130 of the nozzle head 100 in further details, with the inner construction of the nozzle head 100 viewing from the bottom for better visibility. Preferably, the nozzle adjusting mechanism 130 may include the multiple nozzle blade components 110, and further include a pair of upper and lower guide mounts 140, 150 for providing the mechanical transmission between the movement of the trigger handle 136 and the nozzle blade components 110. Preferably, the upper guide mount 140 can be a circular disc which remains stationary throughout the mechanical transmission. The lower guide mount 150 can be a circular disc which is rotatable about an axis when triggered by the trigger handle 136.

In this illustrative example embodiment, there is shown six identical nozzle blade components 110. Each of the nozzle blade components 110 is formed by two parts, with an outer part 112 forming the nozzle tip 28 and an inner part 114 extending vertically and laterally further away from the nozzle tip 28 to form a thin base plate. Each of the base plate 114 is sandwiched between the upper and lower guide mounts 140, 150. The inner part 114 further includes an upper pin 116 extending upwardly from the upper plane of the inner part 114 and a lower pin 118 extending downwardly from the lower plane of the inner part 114. The upper pin 116 may form part of a first pin and slot arrangement for the mechanical transmission between the base plate 114 and the upper guide mount 140. Similarly, the lower pin 118 may form part ofa second pin and slot arrangement for the mechanical transmission between the base plate 114 and the lower guide mount 150.

Advantageously, the lower guide mount 150 may include a plurality of angled straight slots 152 each for receiving a respective lower pin 118 and allow the respective lower pin 118 to slide along the angled slots 152. In this example embodiment, the lower guide mount 150 may include six angled straight slots 152 each being uniformly distributed on the surface of the lower guide mount 150 for receiving a corresponding lower pin 118.

Importantly, each of the slots 152 is oriented at an angle with respect to the radius of the lower guide mount 150 such that the rotation of the lower guide mount 150 would exert an applied force onto each of the lower pin 118 through the contacting surface between the slots 152 and the lower pins 118 so that the xy-components of the resultant force would trigger a two-dimensional movement of the base plate 114. For instance, when the lowerguide mount 150 is rotated anticlockwise, the resultant force acted on each of the lower pin 118 would force the respective base plate 114 to move radially towards the center while tangentially away from the radius in a first direction. As all of the base plates 114 would be forced to move tangentially away from the center simultaneously, this would result in an expanded opening 120. Similarly, when the lower guide mount 150 is rotated clockwise, the resultant force acted on each of the lower pin 118 would force the respective base plate 114 to move radially away from the center while tangentially towards the radius in a second direction opposite to the first direction. As all of the base plates 114 would be forced to move towards the center simultaneously, this would result in a closed or reduced opening 120.

Preferably, the upper guide mount 140 may also include a plurality of angled straight slots 142 for receiving the upper pin 116 and allow the upper pin 116 to slide along the angled slots 142. Similar to the orientation of the slots 152, the slots 142 are oriented at an angle with respect to the radius of the upper guide mount 140. However, the upper guide mount 140 would remain stationary all the time and would not actively drive the movement of the base plate 114. Rather, the angled slots 142 would serve the purpose of guiding the upper pin 116 so as to ensure a smooth sliding movement of the base plate 114. For instance, when the base plate 114 is driven by the lower guide mount 150 and moves radially and tangentially with respect to the radius of the lower guide mount 150, the rotation of the base plate 114 relative to the upper guide mount 140 would also exert an applied force onto the upper pin 116 so that the xy-components of the resultant force would also trigger a two-dimensional movement of the base plate 114.

While the angled slots 142 on the upper guide mount 140 and the angled slots 152 on the lower guide mount 150 are both straight slots in this example embodiment, they can also be replaced with curved slots.

Preferably, the lower guide mount 150 may also include a central aperture 154 for exposing the outer part 112 of the nozzle blade components 110 such that the nozzle tip 28 may deposit the food ink without being obstructed.

Optionally, there is also provided a housing 160 for encasing the various components of the nozzle adjusting mechanism 130. In particular, the housing 160 can be a cylindrical casing which defines a three-dimensional cylindrical volume with a circular cross section. The outer diameter of the lower guide mount 150 has to be slighter smaller than the internal diameter of the circular cross section of the housing 160 to reduce the friction between the lower guide mount 150 and the inner wall of the housing 160. On the top cover of the housing 160, there is also provided a circular slot 162 through which the trigger handle 136 may be extended and exposed thus become accessible by the Y-shaped push arm 134. The two ends of the circular slot 162 may also serve as a stopper so as to limit the circular distance travelled by the trigger handle 136.

While the lower guide mount 150 and the base plate 114 are both movable, the upper guide mount 140 will remain stationary such that the relative movement between the base plate 114 and the upper guide mount 140 will be converted into the movement of the base plate 114. To achieve this, the movement of the upper guide mount 140 may also be limited by the housing 160. For instance, the outer diameter of the upper guide mount 140 should be approximately equal to the internal diameter of the circular cross section of the housing 160 so that the upper guide mount 140 may be pressed fit with the inner wall of the housing 160. On the perimeter of lower housing portion 160, there is also provided a pair of slots 163, 164 which may tight fit with a pair of tabs 144 extending radially from the circumference of the upper guide mount 140. The entire housing 160 may be closed by a lid 165. Additionally, there is also provided a pair of mounting brackets 166, 168 for securely mounting the casing 160 onto the movable station 30. For instance, the housing 160 can be fastened to the mounting brackets 167, 168 by fastening means such as bolts and nuts, screws etc.

In one alternative example not shown in the figures, the upper guide mount 140 may be integrally formed with the lower guide mount 150 and rotatable together with the lower guide mount 150. Upon the lower guide mount 150 is driven by the trigger handle 136, the upper guide mount 140 would also be driven by the lower guide mount 150 and as a result, the slots 152 on the lower guide mount 150 would exert an applied force onto each of the lower pins 118 through the contacting surface between the slots 152 and the lower pins 118 and simultaneously, the slots 142 on the upper guide mount 140 would exert an applied force onto each of the upper pins 116 through the contacting surface between the slots 142 and the upper pins 116. Thus, the upper guide mount 140 may also actively drive the movement of the base plate 114.

Referring now to FIG. 5 for the detailed description of the geometry of lower guide mount 150. The angled slot 152 may be configured with a preferred orientation so as to predefine the amount of displacement of the two-dimensional movement of the base plate 114 by the resultant force. For instance, an imaginary line 156 extended from the longitudinal length of the angled slot 152 may form an acute angle with an intersecting center line 158 of the lower guide mount 150. Preferably, the acute angle may be in the range between 20 to 30 degrees. For instance, a greater angle may increase the radial displacement of the base plate 114 while a smaller angle may decrease the radial displacement of the base plate 114. Thus, the greater the inclination is the slot 152, the greater the displacement of the base plate 114 per angle of rotation of the trigger handle 136 and the lower guide mount 150. The rotation of the trigger handle 136 and the inclined angle of the slot 152 together define the rate of change of the opening 120.

With reference now finally to FIGS. 6A and 6B, there is shown the nozzle head 100 in close condition and open condition respectively. Initially, the main control unit will determine the dimension of the food ink input and derive the required dimension of the opening 120 for extruding the respective food ink. The required dimension would also be determined based on other parameters such as the texture, viscosity etc. of the food ink.

To print a food ink with a larger diameter, the main control unit will command the external servo actuator 132 to generate a circular motion in a clockwise direction (viewing from the bottom of the food printer 10) and the Y-shaped push arm 134 will shift the trigger handle 136 towards the right and the lower guide mount 150 will be rotated anticlockwise by the trigger handle 136. Meanwhile, the angled slot 152 on each of the lower guide mount 150 will force the respective nozzle blade components 110 to move tangentially away from the center. The relative rotation of each of the base plate 114 with respect to each of the corresponding upper guide mount 140 will also exert a force through the angled slot 142 to move the nozzle blade components 110 tangentially away from the center. Accordingly, each of the base plate 114 will move away from the center and each of the outer part 112 carried by the corresponding base plate 114 will also move away from the center to uncover a central opening 112 or an opening 112 with an increased diameter. The main control unit may then command the syringe 24 to extrude the food ink through the extrusion nozzle tip 28 formed by the nozzle blade components 110.

However, to print a food ink with a smaller diameter, the main control unit will command the external servo actuator 132 to generate a circular motion in an anti-clockwise direction (viewing from the bottom of the food printer 10) and the Y-shaped push arm 134 will shift the trigger handle 136 towards the left and the lower guide mount 150 will be rotated clockwise by the trigger handle 136. Meanwhile, the angled slot 152 on each of the lower guide mount 150 will force the respective nozzle blade components 110 to move tangentially towards the center. The relative rotation of each of the base plate 114 with respect to each of the corresponding upper guide mount 140 will also exert a force through the angled slot 142 to move the nozzle blade components 110 tangentially towards the center. Accordingly, each of the base plate 114 will move towards the center and each of the outer part 112 carried by the corresponding base plate 114 will also move towards the center to reduce the diameter of the central opening 112. The main control unit may then command the syringe 24 to extrude the food ink through the extrusion nozzle tip 28 formed by the nozzle blade components 110.

Finally, the routine printing of a food item by the food printer 10 with the nozzle head 100 in accordance with one example embodiment will now be described, by way of example of the food printing of an edible slice of cake formed by a stacked layer structure. In this illustrative example embodiment, the main control unit of the food printer 10 may execute an instruction to print a three-dimensional cake using several ingredients. In this embodiment, the food printer 10 may contain multiple capsules for storing different ingredients and each capsule may be in fluid communication with the nozzle head 100. For instance, the ingredients may include a cracker paste formed by premixing water, butter and graham crackers and other ingredients such as peanut butter, jelly, chocolate spread and fruit jam. These ingredients are each prestored in separate capsules and in fluid communication with the syringe-type extrusion mechanism 20 of the food printer 10. Upon receiving the instruction, the main control unit can emit a signal and instruct the syringe-type extrusion mechanism 20 to draw the required ingredient from the corresponding capsule and subsequently extrude the ingredient via the nozzle tip 28 onto the printing plate or building platform.

As each of these ingredients have different viscosity i.e., resistance to change in shape, they are discharged via a nozzle tip with the same diameter of opening in different flow rate. For instance, the cracker paste has a lower viscosity so that it may be rigid enough to form the foundation of the cake. Ingredient with lower viscosity such as fruit jam would be the wetter ingredient and needs to be supported by the printing structure. Importantly, the higher viscosity the food ink is, the lower the flow rate of the food ink would be and vice versa. In addition, the flow rate of the food ink is also determined by other factors such as the diameter of the opening. For instance, if the nozzle opening 120 is large enough, the large central region of the food ink will flow with uniform velocity. If the nozzle opening 120 is too small, the velocity of the food ink may vary throughout the cross section of the nozzle opening 120. Thus, the dimension of the nozzle opening 120 should be varied to discharge ingredients with different viscosities. For instance, ingredients with lower viscosity should be discharged through a greater nozzle opening 120 while ingredient with high viscosity should be discharged through a smaller nozzle opening 120.

The printing process of the cake will now be described. The cracker paste layer and each of the layers formed by the wetter ingredients will be printed in an alternating manner so that each ingredient layer will be sandwiched by two cracker paste layers. Initially, the main control unit may emit a signal and command the extrusion nozzle tip 28 to discharge the cracker paste onto the printing plate to form the bottom cracker paste layer. To achieve this, the main control unit may command the servo actuator 132 so that the trigger handle 136 may be depressed by the push arm 134 and rotate in a first direction to adjust the relative position between the nozzle blade components 110 and contract the nozzle opening 120. At the same time, the main control unit may also command the motor 20 so that the syringe 24 may extrude the cracker paste from the capsule. Throughout the printing of the bottom cracker paste layer, the main control unit will command the axis motors to move the extrusion nozzle tip 28 along a predefined path covering all the required x,y coordinates for forming the bottom cracker paste layer. Once the printing of the bottom cracker paste layer is completed, it will proceed to the printing of the wetter ingredients such as peanut butter, jelly, chocolate spread and fruit jam. To print these ingredients with lower viscosity, the main control unit may command the servo actuator 132 so that the trigger handle 136 may be depressed by the push arm 134 and rotate in an opposite direction to adjust the relative position between the nozzle blade components 110 and expand the nozzle opening 120. At the same time, the main control unit may also command the motor so that the syringe 24 may extrude the peanut butter from the capsule. The main control unit will command the axis motors to move the extrusion nozzle tip 28 along a predefined path covering all the required x,y coordinates for forming the peanut butter layer.

In order to print the rest of the layers, the main control unit may command the servo actuator 132 to adjust the relative position between the nozzle blade components 110 and control the size of the nozzle opening 120 for extruding each ingredient based on their viscosities. The main control unit will command the axis motors so that the extrusion nozzle tip 28 will navigate through all the required x,y coordinates for each layers until the printing of the top layer is completed.

In an alternative scenario, the entire food object may be printed by the same food ink in which the lower layer would not require good resolution and only the upper layer would require good resolution. As it would be appreciated, the printing with a high resolution would require more x, y coordinate points than a lower resolution printing and thus more time consuming. The main process unit may control the size of the nozzle opening 120 such that those portions that requires only a low resolution may be printed with a bigger nozzle opening 120 whilst those portions that require higher level of details i.e., higher resolution may be printed with a smaller nozzle opening 120. Accordingly, the required time for the total 3D printing job may be reduced and optimized.

Optionally, the present invention may be additional provided a maintenance function. While the food ink may be cured and thus clotted at the nozzle tip 28, the main control unit may adjust the relative position between the nozzle blade components 110 and thus expand the opening 120 to remove the leftover ingredients being trapped in the nozzle tip 28.

The nozzle of the present invention is advantageous because it provides an automated mechanism which may control and adjust the size of the opening without necessarily the intervening the 3D printing process by an operator. Moreover, the present invention may also provide a one size fit all nozzle which may save the number of nozzles with different diameter of opening.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Any reference to prior art contained herein is not to be taken as an admission that the information is common general knowledge, unless otherwise indicated.

1. A nozzle for a food printer comprising:
a nozzle head in fluid communication with an edible ink source and arranged to discharge one or more edible inks, wherein the nozzle head comprises a plurality of nozzle blade components being movable relative to each other and an opening formed by the plurality of nozzle blade components through which the edible ink is discharged; and
a nozzle adjusting mechanism configured to adjust the relative position of the nozzle blade components whereby the dimension of the opening of the nozzle head is adjustable to discharge edible ink with different dimensions so as to print a food material.

2. A nozzle in accordance with claim 1, wherein the nozzle adjusting mechanism further includes a movable mount plate arranged to actuate the relative movement of the nozzle blade components.

3. A nozzle in accordance with claim 2, wherein the nozzle adjusting mechanism further includes a stationary mount plate arranged to guide the relative movement of the nozzle blade components.

4. A nozzle in accordance with claim 3, wherein the nozzle adjusting mechanism further includes a first pin and slot arrangement for transmitting the motion from the movable mount plate to the nozzle blade components.

5. A nozzle in accordance with claim 3, wherein the nozzle adjusting mechanism further includes a second pin and slot arrangement for guiding the movement of the nozzle blade component relative to the stationary mount plate.

6. A nozzle in accordance with claim 3, wherein the nozzle blade components each includes an outer portion together forming the nozzle head and an inner portion interacting with the movable mount plate and the stationary mount plate respectively so as to adjust the position of the outer portion and the dimension of the opening.

7. A nozzle in accordance with claim 6, wherein the outer portion of the nozzle blade component is exposed from the movable mount plate and the inner portion of the nozzle blade component is sandwiched between the movable mount plate and the stationary mount plate.

8. A nozzle in accordance with claim 7, wherein the movable mount plate is a circulate guide mount rotatable about a rotating axis and includes an opening through which the outer portion is exposed.

9. A nozzle in accordance with claim 7, wherein the stationary mount plate is a circulate guide mount being stationary relative to the movable mount plate.

10. A nozzle in accordance with claim 7, wherein each of the inner portion of the nozzle blade component includes a first pin extending vertically from a plane of the nozzle blade component and the movable mount plate further includes a first plurality of slots each receiving a respective first pin of the nozzle blade component whereby the movement of each nozzle blade component is driven by the interaction between the first pins and the slots.

11. A nozzle in accordance with claim 10, wherein each of the inner portion of the nozzle blade component includes a second pin extending vertically from a plane of the nozzle blade component and the stationary mount plate further includes a second plurality of slots each arranged to mate with a respective second pin of the nozzle blade component so as to facilitate the movement of each nozzle blade component driven by the movable mount plate.

12. A nozzle in accordance with claim 11, wherein the longitudinal length of the first slot forms an acute angle with a center line of the movable mount plate.

13. A nozzle in accordance with claim 1, wherein the movable mount plate further includes a trigger handle protruding from the movable mount plate and the nozzle adjusting mechanism further includes a push arm driven by an actuator whereby the position of the movable mount plate is manipulated by the actuator through the mechanical transmission from the push arm to the trigger handle.

14. A nozzle in accordance with claim 13, wherein the push arm is pivotable about a pivoting axis whereby the pivotal movement of the push arm is arranged to push the trigger handle so as to adjust the dimension of the opening.

15. A nozzle in accordance with claim 14, wherein the push arm includes two extending arms each operable to push the trigger handle from opposite directions respectively.

16. A nozzle in accordance with claim 1, wherein the nozzle adjusting mechanism is actuated by a servo actuator.

17. A nozzle in accordance with claim 13, further comprising a housing arranged to contain the nozzle adjusting mechanism.

18. A nozzle in accordance with claim 17, wherein the housing further includes a slot through which the trigger handle is exposed from the housing so as to be accessible by the push arm and the two ends of the slot being a stopper whereby the degree of the movement of the trigger handle is limited.

19. A nozzle in accordance with claim 1, wherein at least one of the nozzle blade components is symmetrical.

20. A nozzle in accordance with claim 1, wherein at least two of the nozzle blade components are identical.
